(19) United States
(12) Patent Application Publication
(10) Pub. No.: US 2016/0250858 A1
(43) Pub. Date: Sep. 1, 2016

(54) METHOD OF CLEANING INK JET APPARATUS AND INK JET APPARATUS

(71) Applicant: Seiko Epson Corporation, Tokyo (JP)

(72) Inventors: Keitaro NAKANO, Matsumoto (JP); Teruaki KAIEDA, Matsumoto (JP)

(21) Appl. No.: 15/051,998

(22) Filed: Feb. 24, 2016

(30) Foreign Application Priority Data
Feb. 26, 2015 (JP) 2015-036437

(51) Int. Cl. B41J 2/165

(52) U.S. Cl. CPC B41J 2/16535; B41J 2/16532

(57) ABSTRACT

Provided is a method of cleaning an ink jet apparatus which discharges a radiation-curable ink jet composition, the method including wiping a nozzle surface of an ink jet head by using a wiping section that is provided with an absorber which is impregnated with an organic solvent containing glycol ethers.

### BACKGROUND

1. Technical Field

The present invention relates to a method of cleaning an ink jet apparatus and an ink jet apparatus which performs the cleaning.

2. Related Art

A radiation-curable ink jet composition which is cured with light irradiation and is used in sign making has been widely used in printing. In a case where an image and text are recorded by using liquid droplets of fine ink jet compositions (hereinafter, simply referred to as “ink”) which are discharged from a nozzle of an ink jet head, if the ink is attached on a nozzle surface on which the nozzle is provided, the moisture or other volatile components contained in the ink are evaporated, and thereby the ink attached on the nozzle surface may be thickened or solidified. For this reason, the ink attached on the nozzle surface may result in obstruction of a normal discharge of ink. The radiation-curable ink jet composition has high viscosity compared with the ink in the related art, and since the ink attached on the nozzle surface is cured and thickened due to reflection light, leakage light, and the like, the ink attached on the nozzle surface cannot be completely removed by being wiped only with a general silicon based rubber wiper.

In this regard, for example, a method of wiping the ink attached on the nozzle surface in a such a manner that an ink absorber such as a fabric wiper is impregnated with a solvent and then comes in contact with the nozzle surface. For example, JP-A-2009-274258 discloses that examples of the solvent with which the fabric wiper is impregnated include glycol ethers, and particularly include diethylene glycol dibutyl ether and triethylene glycol monomethyl ether.

However, when the ink is wiped in such manner that the ink absorber comes in contact with the nozzle surface by using the solvent disclosed in JP-A-2009-274258, an aggregate of the ink, and particularly, an aggregate derived from an inorganic pigment are scraped at the time of wiping the ink, and thus, the nozzle surface is scratched. Therefore, it is not possible to obtained sufficient wiping properties.

### SUMMARY

An advantage of some aspects of the invention is to provide a method of cleaning an ink jet apparatus which prevents radiation-curable ink jet compositions from being aggregated, and has excellent cleaning properties, and an ink jet apparatus which performs the cleaning.

The invention can be realized in the following aspects or application examples.

### APPLICATION EXAMPLE 1

According to an aspect of the invention, there is provided a method of cleaning an ink jet apparatus which discharges a radiation-curable ink jet composition, the method including wiping a nozzle surface of an ink jet head by using a wiping section that is provided with an absorber which is impregnated with an organic solvent containing glycol ethers.

According to the method of cleaning an ink jet apparatus in Application Example 1, it is possible to provide a method of cleaning an ink jet apparatus which prevents the radiation-curable ink jet compositions from being aggregated and has excellent cleaning properties by wiping the ink using a wiping member which is provided with the absorber which is impregnated with a impregnation liquid containing glycol ethers.

### APPLICATION EXAMPLE 2

In the cleaning method according to Application Example 1, the number of carbons of the glycol ethers may be equal to or greater than 8.

### APPLICATION EXAMPLE 3

In the cleaning method according to Application Example 1 or Application Example 2, the glycol ethers may be glycol ether ester.

### APPLICATION EXAMPLE 4

In the cleaning method according to any one of Application Example 1 to Application Example 3, the absorber which is impregnated with the organic solvent may be on standby while discharging the radiation-curable ink jet composition to the recording medium, and then the wiping may be performed after the discharging of the radiation-curable ink jet composition.

### APPLICATION EXAMPLE 5

In the cleaning method according to any one of Application Example 1 to Application Example 4, the radiation-curable ink jet composition may be a radiation-curable composition containing a polymerizable compound having three or more functional groups.

### APPLICATION EXAMPLE 6

In the cleaning method according to any one of Application Example 1 to Application Example 5, the absorber may be further impregnated with a surfactant.

### APPLICATION EXAMPLE 7

In the cleaning method according to Application Example 6, the surfactant may be at least one selected from the group consisting of polyether-modified silicone, polyester-modified silicone, and acetylene diol.

### APPLICATION EXAMPLE 8

According to another aspect of the invention, there is provided an ink jet apparatus that performs cleaning through the cleaning method according to any one of Application Example 1 to Application Example 7.

### BRIEF DESCRIPTION OF THE DRAWINGS

The invention will be described with reference to the accompanying drawings, wherein like numbers reference like elements.

FIG. 1 is a diagram schematically illustrating an ink jet apparatus according to an embodiment of the invention.

FIG. 2 is a diagram schematically illustrating a nozzle surface of the ink jet apparatus according to the embodiment of the invention.

FIG. 3 is a perspective view schematically illustrating a wiper unit of the ink jet apparatus according to the embodiment of the invention.

FIG. 4A and FIG. 4B are front views schematically illustrating a wiper cassette of the ink jet apparatus according to the embodiment of the invention.

### DESCRIPTION OF EXEMPLARY EMBODIMENTS

Hereinafter, the preferred embodiments of the invention will be described. The embodiments described below are intended to describe examples of the invention. In addition, the invention is not limited to the following embodiments, but includes various modification examples employed in the scope without changing the gist of the invention. Note that, not all of the configurations described below are the essential configuration of the present invention.

### 1. CLEANING METHOD

A method of cleaning an ink jet apparatus according to the embodiment of the invention includes wiping a nozzle surface of an ink jet head by using wiping section which is provided with an absorber which is impregnated with an organic solvent containing glycol ethers, in an ink jet apparatus which discharges a radiation-curable ink jet composition.

Hereinafter, regarding the method of cleaning an ink jet apparatus according to the embodiment, a configuration of a device which can perform the cleaning, an impregnation liquid (an organic solvent), and a radiation-curable ink jet composition will be sequentially described, and the steps thereof will described in detail.

### 1.1. Configuration of Apparatus

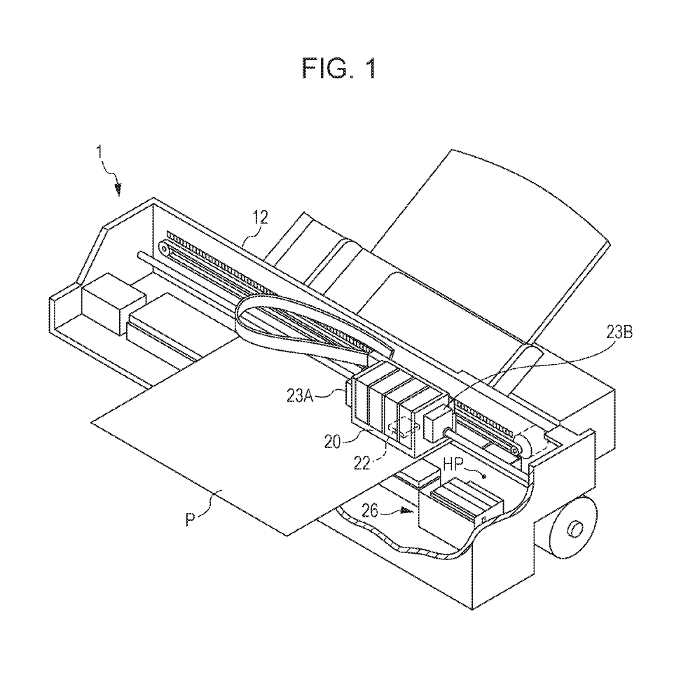

The ink jet apparatus which performs the cleaning method according to the embodiment includes a nozzle surface on which a nozzle for discharging a radiation-curable ink jet composition is provided, and a wiping section which includes an absorber which is impregnated with an impregnation liquid. Examples of such an ink jet apparatus include an ink jet printer as illustrated in FIG. 1. An ink jet printer 1 illustrated in FIG. 1 is formed by incorporating a head cleaning device 26 into a known ink jet printer.

The ink jet printer 1 includes a carriage 20 on which an ink jet head 22 for ejecting radiation-curable ink jet compositions as liquid droplets having a fine particle size onto a recording medium P from a nozzle is mounted. Both ends of the carriage 20 in a moving direction are provided with a pair of active radiation irradiation devices 23A and 23B for applying active radiation to the liquid droplet of the radiation-curable ink jet composition which is discharged from the ink jet head 22 and attached onto the recording medium P. As illustrated in FIG. 1, the active radiation irradiation device 23A which is attached on the left side toward the ink jet head 22 applies the active radiation to the liquid droplets discharged onto the recording medium P when rightward scanning is performed by moving the carriage 20 in the rightward direction. On the other hand, the active radiation irradiation device 23B which is attached on the right side toward the ink jet head applies the active radiation to the liquid droplets discharged onto the recording medium P when leftward scanning is performed by moving the carriage 20 in the leftward direction. The active radiation irradiation devices 23A and 23B are provided with an active radiation source (not shown), and examples of the active radiation source include a light emitting diode (LED) and a laser diode (LD).

### 1.1.1. Nozzle Surface

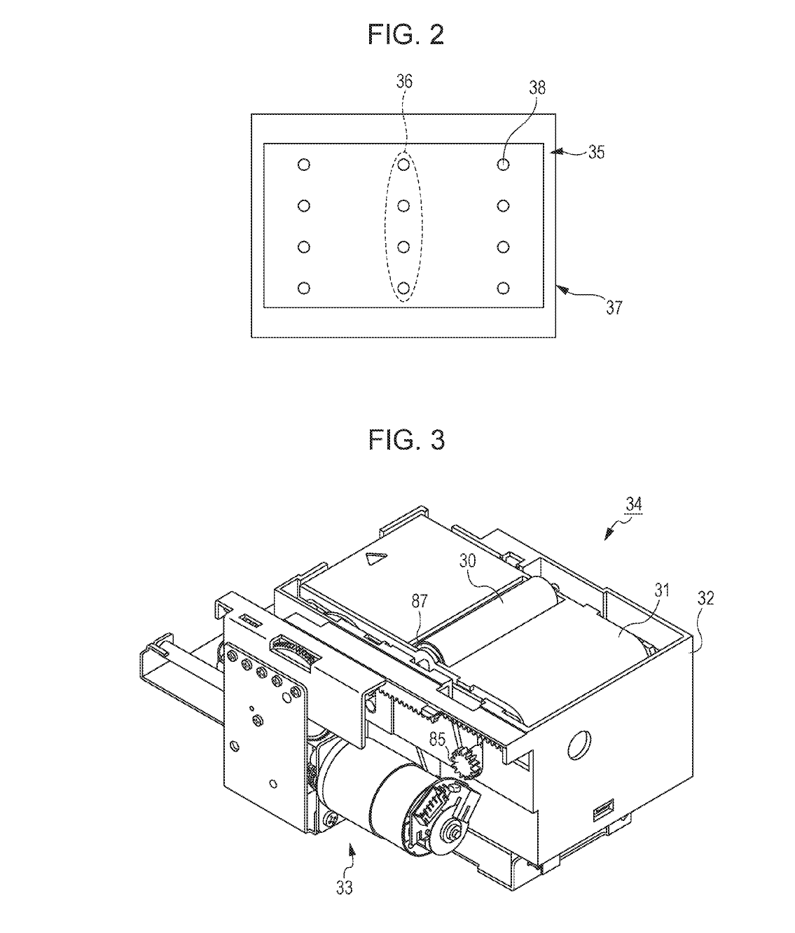

The ink jet head 22 is a serial type head for full color printing which ejects a plurality of color inks, and includes a plurality of nozzles for each color. FIG. 2 is a diagram schematically illustrating a nozzle surface. As illustrated in FIG. 2, a nozzle surface 37 is formed on a surface facing the recording medium P of the ink jet head 22. The nozzle surface 37 is provided with a plurality of nozzles (nozzle openings) 38 which discharge the radiation-curable ink jet compositions. The nozzles 38 which are arranged in a plurality of rows in a certain direction form a nozzle row 36. As illustrated in FIG. 2, the nozzle surface 37 is provided with a plurality of the nozzle rows 36.

The nozzle surface 37 may be provided with a liquid-repellent film (not shown). The liquid-repellent film is not particularly limited, as long as it is a film having liquid repellency. For example, a molecular film of metal alkoxide having the liquid repellency can be formed as the liquid-repellent film through a drying step, an annealing step, and the like. The molecular film of metal alkoxide is not particularly limited, as long as it has the liquid repellency; however, it is preferable to use a monomolecular film of metal alkoxide having a long-chain polymer group containing a fluorine (a long-chain RF group), or a monomolecular film of metal salt having a liquid repellent group (for example, a long-chain polymer group containing a fluorine). The metal alkoxide is not particularly limited; however, examples of metals thereof generally include silicon, titanium, aluminum, and zirconium. Examples of the long-chain RF group include a perfluoroalkyl chain and a perfluoropolyether chain. Examples of the alkoxysilane having the long-chain RF group include a silane coupling agent having the long-chain RF group. The liquid-repellent film is not particularly limited, for example, it is possible to use a silane coupling agent (SCA) film or a film which is disclosed in Japanese Patent No. 4424954. Note that, a film particularly having the water repellency is referred to as a water-repellent film.

In addition, the liquid-repellent film may be formed on the conductive film by forming a conductive film on a substrate (a nozzle plate) on which the nozzle is provided, and also may be formed on a base film (a plasma polymerization silicone (PPSi) film) which is formed by performing plasma polymerization on a silicone material. It is possible that a silicone material of a nozzle plate and the liquid-repellent film are adapted to each other via the above base film.

The thickness of the liquid-repellent film is preferably in a range of 1 nm to 30 nm, is more preferably in a range of 1 nm to 20 nm, and is still more preferably in a range of 1 nm to 15 nm. When the thickness of the liquid-repellent film within the above described range, there is a tendency that the nozzle surface is further excellent in the liquid repellency, and thus, the deterioration of the film is relatively slow, thereby maintaining the liquid repellency for a long period of time. In addition, it is advantageous to film formation and cost reduction.

The nozzle surface 37 may be provided with a nozzle plate cover which covers at least a portion of the nozzle surface 37. In the example illustrated in FIG. 2, the nozzle plate cover 35 is provided so as to surround the entirety of the nozzle rows 36 (nozzles 38). The nozzle plate cover 35 is provided so as to serve at least one of a role of fixing a plurality of nozzle chips (hereinafter, simply referred to as “chip”) and a role of preventing a recording medium from being floated and coming in contact with the nozzle 38 on the nozzle surface 37 of the ink jet head 22 which is formed by combining the plurality of nozzle chips. In addition, the nozzle plate cover 35 covers at least a portion of the nozzle surface 37, and is provided so as to protrude from the nozzle when seen from the side surface. In a case where the nozzle plate cover 35 is provided, the radiation-curable ink jet composition is likely to remain at a corner (gap) between the nozzle surface 37 and the nozzle plate cover 35 protruding from the nozzle surface 37, a pigment and the like of the remaining radiation-curable ink jet composition is caused to be solidified, a cap and the nozzle surface are insufficiently come in close contact with each other, and thereby a capping operation may be deteriorated. The deterioration of the capping operation becomes remarkable in accordance with the type of resin contained in the radiation-curable ink jet composition. Here, a wiping section described below comes in contact with a space between the nozzle plate cover 35 and the nozzle 38, and thus, it is possible to remove the radiation-curable ink jet compositions accumulated on the aforementioned gap, and thus, it is possible to perform a stable and excellent capping operation.

When performing a wiping step described below, the wiping is performed on the nozzle surface 37 while the impregnation liquid is attached to the nozzle 38. Specifically, when the wiping step is performed, the absorber of the wiping section is impregnated with the impregnation liquid in advance, and the nozzle surface 37 is wiped by the absorber of the wiping section which holds the impregnation liquid.

### 1.1.2. Wiping Section

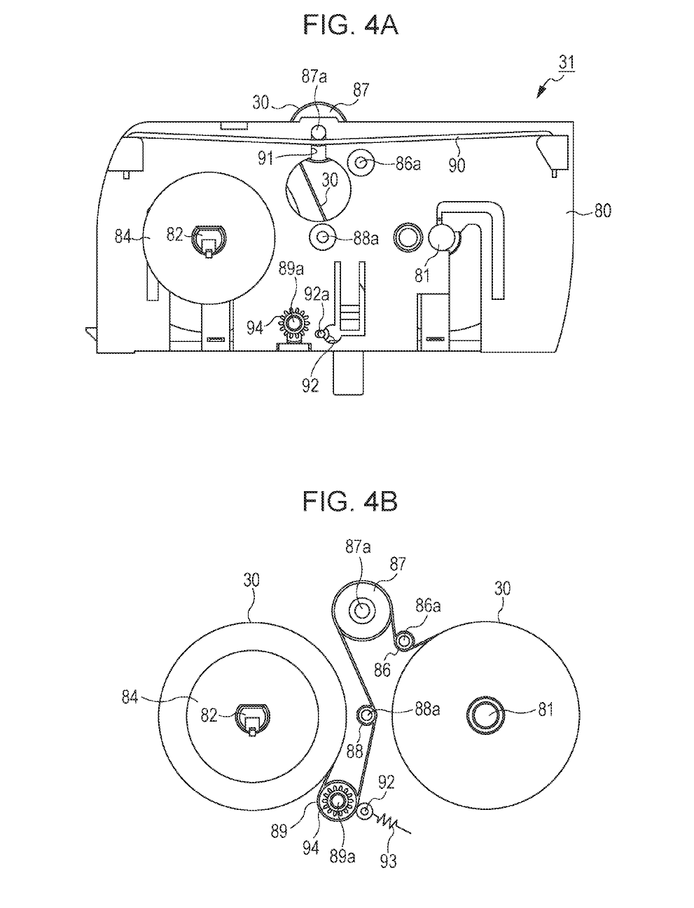

As illustrated in FIG. 1, the head cleaning device 26 which cleans the ink jet head 22 is provided in a home position HP provided on the right side of a recording area to which a recording medium P is transported in a frame 12. FIG. 3 is a perspective view schematically illustrating a wiper unit 34 which is an example of the head cleaning device 26. FIG. 4A is a front view of the wiper unit 34, and FIG. 4B is a front view of the wiper unit 34 without the housing.

The wiper unit 34 includes a wiper cassette 31 in which a wiping section 30 is built, a wiper holder 32 on which the wiper cassette 31 is detachably mounted, and a moving mechanism 33 which moves the wiper holder 32 in a nozzle row direction of the ink jet head 22 (a transporting direction of the recording medium P in FIG. 1). In addition to the wiper unit 34 illustrated in FIG. 3, the head cleaning device 26 may include a cap (not shown) which comes in contact with the nozzle surface 37 of the ink jet head 22 so as to surround the nozzle 38, and a suction pump (not shown) which is driven so as to suction and discharge the ink which is thickened or the like as waste ink from the inside of the ink jet head 22 via the cap.

As illustrated in FIGS. 4A and 4B, in a housing 80 which is formed into an approximately rectangular shape which forms the appearance of the wiper cassette 31, a pair of rollers 81 and 82 which have an axial line horizontally extending in a frontward and rearward direction corresponding to a lateral direction of the housing 80 are accommodated at a distance in a leftward and rightward direction corresponding to a longitudinal direction of the housing 80. The wiping section 30 which is formed into a long shape and wipes the ink from the nozzle surface 37 of the ink jet head 22 is installed between the pair of rollers 81 and 82. In addition, among the pair of rollers 81 and 82, the feeding roller 81 which is provided on the left side close to the recording area where the ink jet head 22 performs a recording operation with respect to the recording medium P, feeds the wiping section 30 which is wound and unused. On the other hand, among the pair of rollers 81 and 82, a winding roller 82 which is provided on the right side close to the side opposite to the recording area where the ink jet head 22 performs the recording operation with respect to the recording medium P winds the used wiping section 30 which is unwound from the feeding roller 81 so as to be used in the wiping. In addition, the feeding roller 81 and the winding roller 82 are positioned at approximately the same height as each other. Further, a feeding gear is rotatably integrated with the feeding roller 81 at one end portion (a front end portion) of the feeding roller 81 which is exposed to the outside of the housing 80 in the axial direction. In addition, winding gears 84 and 85 are rotatably integrated with the winding roller 82 at both end portions of the winding roller 82 which is exposed to the outside of the housing 80 in the axial direction.

In addition, in the housing 80, a plurality of (four rollers in the embodiment) rollers 86, 88, and 89, and a press member 87 are provided on a feeding path of the wiping section 30 from the feeding roller 81 to the winding roller 82. These rollers 86, 88, and 89, and the press member 87 extend in parallel with the feeding roller 81 and the winding roller 82 in the frontward and rearward direction, and both ends in the frontward and rearward direction are rotatably supported by a shaft receiving portion which is provided on a side wall portion of the housing 80.

Specifically, a portion fed from the feeding roller 81 in the wiping section 30 is wound to the press member 87 which is provided diagonally to the upper right side of the feeding roller 81. A shaft portion 87a at both ends of the press member 87 in the axial direction is supported from below by a rod spring 90 which is fixed onto outside surfaces of both front and rear sides of the housing 80. The rod spring 90 supports the shaft portion 87a of the press member 87 in the middle of the longitudinal direction from below. Meanwhile, the shaft portion 87a of the press member 87 is inserted into a shaft receiving hole 91 in the frontward and rearward direction which is provided in the housing 80, and comes in close contact with a hole edge in accordance with a biasing force upwardly generated by the rod spring 90 the shaft receiving hole 91. In addition, the shaft portion 87a of the press member 87 is rotatably supported by both upper and lower sides between the rod spring 90 and the edge of the shaft receiving hole 91. In addition, a top portion on a peripheral surface in the press member 87 is positioned above further than a top surface of the housing 80, and the portion which is wound to the press member 87 in the wiping section 30 protrudes upward from the top surface of the housing 80. Further, the top portion of the peripheral surface in the press member 87 is positioned above further than the nozzle surface 37 of the ink jet head 22.

The driving mechanism which includes at least the rod spring 90 and the press member 87 can add a pressing load on the wiping section 30 by pressing the wiping section including the impregnation liquid with respect to the nozzle surface 37 by upward biasing force generated by the rod spring 90. In the embodiment, the pressing load represents a spring load. Note that, a mechanism which applies the pressing load is not necessarily a spring, as long as it is possible to press the wiping section 30 with a certain load with respect to the nozzle surface 37. For example, rubber may be used as the mechanism or a method of applying a load by electrically controlling a mechanical member without using the mechanism may be used.

In addition, the relay roller 89 which winds the portion fed form the press member 87 in the wiping section 30 is provided on the perpendicular lower side of the press member 87. Further, a pinching roller 92 which pinches the wiping section 30 between the pinching roller and the relay roller 89 is provided in a position which is on the side opposite to the relay roller 89 with the wiping section 30 interposed therebetween. In addition, a spring member 93 is interposed between an inner surface of a bottom wall of the housing 80 and the pinching roller 92 as a biasing member. In addition, the pinching roller 92 is biased by the spring member 93 in the direction approaching the relay roller 89.

Further, a relay gear 94 is rotatably integrated with the relay roller 89 at an end portion of the shaft portion 89a, which is exposed to the outside from the side wall portion of the housing 80 in the relay roller 89, on one side (rear side in FIGS. 4A and 4B) of the axial direction. In addition, an end portion of the shaft portion 92a at both ends of the pinching roller 92 in the axial direction is exposed to the outside from the shaft receiving portion having a notched groove shape which is formed by notching an elastic piece portion in the side wall portion of the housing 80.

In addition, tension rollers 86 and 88 which apply tension with respect to the wiping section 30 are respectively provided between the feeding roller 81 and the press member 87, and between the press member 87 and the relay roller 89 on the feeding path of the wiping section 30 from the feeding roller 81 to the winding roller 82. Further, end portions of shaft portions 86a and 88a at both ends of the tension rollers 86 and 88 in the axial direction are exposed to the outside from the circular-concave shaft receiving portion which is provided on the side wall portion of the housing 80.

The wiping section 30 offers an absorber (not shown) on the surface facing the nozzle surface 37. The absorber is used to clean the nozzle 38 and the nozzle surface 37 in such a manner that the nozzle surface 37 is wiped with the absorber holding the impregnation liquid, and then the absorber absorbs or adsorbs foreign matter (for example, the radiation-curable ink jet composition, a cured material of the radiation-curable ink jet composition, fiber, paper, and dust) attached on the nozzle 38 and the nozzle surface 37. With this, a pigment particle or a cured material which are contained in the radiation-curable ink jet composition are absorbed in the absorber, and thus, the pigment particle or the cured material does not remain on the surface of the absorber of the wiping section 30. For this reason, it is possible to prevent a water-repellent film which is formed on the nozzle surface 37 from being scratched by the pigment particles or the cured material.

An absorber of the wiping section 30 is not particularly limited, as long as the absorber is an liquid absorptive material, and examples thereof include fabric (textile, knitting, and non-woven fabric), sponge, and pulp. Among them, the fabric is preferably used. The reason for this is that fabric is easily bent and it is easy to wipe the ink attached on the nozzle surface 37 by using fabric particularly when the nozzle plate cover 35 is provided. The material for forming fabric is not particularly limited; however, examples thereof include cupra, polyester, polyethylene, polypropylene, lyocell, and rayon. At this time, it is preferable to select a material which is not easily deteriorated by the impregnation liquid.

The thickness of the absorber can be properly set if required; for example, it can be set to be in a range of 0.1 mm to 3 mm. When the thickness is set to be equal to or greater than 0.1 mm, it is easy to hold the impregnation liquid. In addition, when the thickness is set to be equal to or less than 3 mm, a compact wiping section is realized and thus, it is possible to realize size reduction of the entire wiper unit, and mechanical transport of the wiping section is easily performed.

The areal density of the absorber is preferably in a range of 0.005 g/cm² to 0.15 g/cm², and is more preferably in a range of 0.02 g/cm² to 0.13 g/cm². When the areal density is within the above range, it is easier to hold the impregnation liquid. Further, in order to hold the impregnation liquid, fabric of which the areal density and the thickness are easily designed is preferably used as the absorber.

It is preferable that the absorber holds the impregnation liquid at the time of shipping. With this, it is possible to immediately perform the wiping of the nozzle surface 37, and thus, there is no need to provide a mechanism which ejects or applies the impregnation liquid to the nozzle surface 37. Here, the phrase “holds the impregnation liquid at the time of shipping” means a state where the absorber of the wiping section already holds the impregnation liquid when the ink jet apparatus including the wiping section is installed, a state where the absorber of the wiping section already has the impregnation liquid when the wiping section is installed in the ink jet apparatus, and a state where the absorber of the wiping section for the exchange holds the impregnation liquid. In this regard, the phrase “the installment of the ink jet apparatus” means that the ink jet apparatus is provided so as to be used for the first time, and the phrase “the installment of the wiping section” means that the wiping section is provided so as to be used for the first time. In the embodiment, the wiping of the nozzle surface 37 by using the wiping section 30 may be performed by wiping at least the nozzle surface 37 by using the wiping section 30, and it is preferable that at least a portion of the foreign matter attached on the nozzle surface 37 is wiped by the aforementioned wiping. Note that, it is preferable that an amount of the impregnation liquid held in the absorber is set to the extent that the water-repellent film which is formed on the nozzle surface 37 is not scratched and handleability is not deteriorated.

### 1.1.3. Driving Mechanism

The ink jet apparatus according to embodiment includes a driving mechanism. The driving mechanism is a unit that causes at least one of the wiping section 30 and the ink jet head 22 to relatively move with respect to the other one, and then causes the wiping section 30 to perform the wiping step of removing the foreign matter attached on the nozzle surface 37. In addition, the driving mechanism used in the embodiment is a mechanism for pressing the wiping section 30 containing the impregnation liquid and the nozzle surface 37, and is formed of at least the press member 87 and the rod spring 90 in FIG. 4A as described above, and may further include the moving mechanism 33.

The press member 87 relatively presses the wiping section 30 and the nozzle surface 37 in a range of 50 kf to 700 kf, and preferably in a range of 75 kf to 500 kf. When a pressing force is set to be equal to or greater than 50 kf, the cleaning properties become excellent. Further, although there is a step between the nozzle plate and the nozzle plate cover 35, it is possible to prevent the ink from being attached and accumulated in the gap, or to easily remove the attached and accumulated ink from the gap. In addition, when the pressing force is set to be equal to or less than 700 kf, it is possible to perform the wiping without scratching the liquid-repellent film formed on the nozzle surface 37, and thereby the preservability of the liquid-repellent film is further improved.

As described above, the driving mechanism can serve as not only a mechanism for causing the wiping section 30 to be pressed from the side which is opposite to the side coming in contact with the nozzle surface 37 such that the wiping section 30 comes in contact with the nozzle surface 37, but also a mechanism for causing the ink jet head 22 to be driven such that the wiping section 30 and the nozzle surface 37 come in contact with each other. Note that, the load in the description means the total load which is applied to the nozzle surface 37 from the entirety of the driving mechanisms.

Further, in the driving mechanism, it is preferable that the wiping section 30 and the ink jet head 22 are relatively moved at a speed in a range of 1 cm/s to 10 cm/s. When the wiping section 30 and the ink jet head 22 are moved at the speed within the above range, the cleaning property and the preservability of the liquid-repellent film are further improved. Meanwhile, the speed of the cleaning operation is slow approximately ⅕ to 1/20 from the moving speed when the recording head normally records an image; however, the speed is not limited to this speed relationship.

The press member 87 is not particularly limited; however, a material which is covered by an elastic member is preferably used, for example. Shore A hardness of the elastic member is preferably in a range of 10 to 60, and is more preferably in a range of 10 to 50. With this, the press member and the wiping section 30 are bent at the time of being pressed, and thus, it is possible to press the wiping section with respect to an uneven surface of the nozzle surface into the deep part. Particularly, in a case where the nozzle plate cover 35 is present, it is possible to press the wiping section with respect to a corner (gap) between the nozzle surface 37 and the nozzle plate cover 35 protruding from the nozzle surface 37 into the deep part, and thereby it is possible to prevent the ink from being accumulated. As a result, the cleaning properties are further improved.

### 1.2. Impregnation Liquid (Organic Solvent)

In the method of cleaning an ink jet apparatus, the organic solvent containing glycol ethers is used as the impregnation liquid. The impregnation liquid is held in the absorber of the wiping section 30 when performing the wiping step, and thus is attached on the nozzle surface 37. Hereinafter, components contained in the impregnation liquid and components which can be contained in the impregnation liquid will be described below.

### Organic Solvent

The impregnation liquid is an organic solvent containing glycol ethers (hereinafter, referred to as a “specific organic solvent”). The specific organic solvent may be used alone or used in combination with two or more types thereof.

The specific organic solvent is excellent in dissolving (softening) the radiation-curable ink jet composition which is attached on the nozzle surface 37. For this reason, when the specific organic solvent is used as the impregnation liquid, it is possible to suppress the aggregate of the radiation-curable ink jet compositions which are attached on the nozzle surface 37, and the cleaning properties of the nozzle surface 37 are improved. In addition, particularly, in a case of ink containing a polymerizable compound having three or more functional groups, a cured material becomes a highly crosslinkable cured material, and thus is not easily wiped with a wiper; however, the specific organic solvent dissolves (softens) the cured material, and thus the nozzle surface 37 is smoothly wiped by using the aforementioned absorber, thereby clearly cleaning the nozzle surface 37 without scratching. Also, in a case where ink containing an inorganic pigment is used to smoothly wipe the nozzle surface 37, it is possible to clearly clean the nozzle surface 37 without scratching.

In the specific organic solvent, the number of carbons in glycol ethers is preferably equal to or greater than 8. Since the radiation-curable ink jet composition is hydrophobic ink, when the impregnation liquid which comes in contact with the surface is hydrophobic liquid, it is possible to prevent the radiation-curable ink jet compositions from being aggregated, and thus the cleaning properties are further improved. In addition, when the number of carbons in glycol ethers is set to be equal to or greater than 8, the volatility of the impregnation liquid is deteriorated, and thus in a case where the impregnation liquid is used for a long period of time, it is possible to reduce the nozzle clogging which occurs as the impregnation liquid is dried, and the ejection stability of the radiation-curable ink jet composition is further improved.

The glycol ethers are preferably glycol ether ester. A material which belongs to glycol ethers but does not belong to glycol ether ester has a hydroxyl group on one side of a molecule, and thus is easily absorbs moisture, which results in aggregates after wiping. For this reason, among the aforementioned glycol ethers, it is preferable to use glycol ether ester. Specific examples of glycol ether ester include diethylene glycol mono ethyl ether acetate and diethylene glycol monomethyl ether acetate. These organic solvents may be used alone or used in combination with two or more types thereof.

As the above-described specific organic solvent, it is preferable to use a material of which a standard boiling point is equal to or higher than 170° C., and it is more preferable to use a material of which a standard boiling point is equal to or higher than 250° C. With this, it is possible to reduce the nozzle clogging which occurs as the impregnation liquid is dried, and the ejection stability of the radiation-curable ink jet composition is further improved.

As the above-described specific organic solvent, it is preferable to use a material of which a steam pressure is equal to or lower than 1 hPa at 20° C., it is more preferable to use a material of which a steam pressure is equal to or lower than 0.5 hPa, it is still more preferable to use a material of which a steam pressure is equal to or lower than 0.1 hPa, and it is particularly preferable to use a material of which a steam pressure is equal to or lower than 0.01 hPa. Therefore, it is possible to reduce the nozzle clogging which occurs as the impregnation liquid is dried, and the ejection stability of the radiation-curable ink jet composition is further improved.

In addition, as the above-described specific organic solvent, it is preferable to use a material of which the surface tension is in a range of 25 mN/m to 35 mN/m at 20° C. In this case, since the compatibility with the radiation-curable ink jet composition described below is improved, there is a tendency that the cleaning properties are further improved. Meanwhile, the surface tension can be measured in such a manner that the surface tension is checked when a platinum plate is wet by the organic solvent at 20° C. by using an automatic surface tension meter CBVP-Z (manufactured by Kyowa Interface Science Co., Ltd).

In a case of performing the wiping step described below by using the wiping section 30 includes the absorber which is impregnated with the impregnation liquid, a content of the specific organic solvent contained in the impregnation liquid held in the absorber is preferably equal to or greater than 10 parts by mass, is more preferably equal to or greater than 15 parts by mass, is furthermore preferably equal to or greater than 20 parts by mass, is further still preferably equal to or greater than 40 parts by mass, and is particularly preferably equal to or greater than 50 parts by mass, with respect to 100 parts by mass of the absorber. The upper limit value thereof is preferably equal to or less than 150 parts by mass, and is more preferably equal to or less than 100 parts by mass. When content of the specific organic solvent is equal to or greater than 10 parts by mass, the ink solidified on the nozzle surface 37 is easily dissolved (softened), and thus the cleaning properties are further improved. In addition, when content of the specific organic solvent is equal to or less than 150 parts by mass, the ink is easily absorbed in the absorber, and thus it is possible to suppress the occurrence of abnormal discharge or non-discharge of ink from the nozzle 38 due to unwiped ink, thereby improving the ejection stability of ink.

### Surfactant

The impregnation liquid according to the embodiment may further contain a surfactant other than the specific organic solvent and the polymerization inhibitor. When the impregnation liquid contains the surfactant, the surface tension of the impregnation liquid is deteriorated, and wettability with respect to the nozzle surface 37 is enhanced. For this reason, it is possible to not only dissolve (soften) the radiation-curable ink jet composition attached on the nozzle surface 37, but also to prevent the pigment of ink from being attached again on the nozzle surface 37, thereby further improving the cleaning properties of the nozzle surface 37.

As the surfactant, it is preferable to use at least one selected from the group consisting of polyether-modified silicone, polyester-modified silicone, and acetylene diol. With this, the cleaning property is further improved. Specific examples of the surfactant include a silicone-based surfactant (as a commercially available product, for example, BYK UV3700 (product name) manufactured by BYK Japan KK), and an acetylene-based surfactant (as a commercially available product, for example, Surfynol E1010 (product name) manufactured by Nissin Chemical Industry Co., Ltd). The surfactant may be used alone or used in combination with two or more types thereof.

A content of the surfactant in the impregnation liquid is preferably in a range of 0.1 mass % to 10 mass % with respect to the total mass (100 mass %) of the impregnation liquid.

The aforementioned surfactant may be contained in the impregnation liquid as described above, or may be contained in the absorber of the wiping section 30 in advance. In addition, when performing the wiping step, the surfactant may be supplied to and attached on the nozzle surface 37 by using a known spray device or the like. Polymerization inhibitor

The impregnation liquid according to the embodiment may contain the polymerization inhibitor other than the specific organic solvent. When the impregnation liquid contains the polymerization inhibitor, it is less likely that the radiation-curable ink jet composition attached on the nozzle surface 37 is cured by leakage light, heat, or the like, and thus it is possible to prevent the components contained in the radiation-curable ink jet composition from being aggregated, thereby improving the cleaning properties of the nozzle surface 37.

The polymerization inhibitor contained in the impregnation liquid is preferably at least one selected from the group consisting of catechols, hindered amines, phenols, phenothiazines, and quinones of a condensed aromatic ring. With this, it is less likely that the radiation-curable ink jet composition attached on the nozzle surface 37 is cured by the leakage light, and the cleaning properties are further improved.

Among the above-described polymerization inhibitors, from a view point that it is less likely that the radiation-curable ink jet composition attached on the nozzle surface is cured by the leakage light, a photopolymerization initiator is preferably used; however, a polymerization inhibitor which can be used under the condition of applying high heat or the like is not limited to the photopolymerization initiator. Specific examples of the polymerization inhibitor include hydroquinone monomethyl ether, and 4-hydroxy-2,2,6,6-tetramethyl piperidine-N-oxyl. The polymerization inhibitor may be used alone or used in combination with two or more types thereof.

A content of the polymerization inhibitor in the impregnation liquid is preferably in a range of 0.1 mass % to 1 mass % with respect to the total mass (100 mass %) of the impregnation liquid. When the content of the polymerization inhibitor in the impregnation liquid is within the above range, it is less likely that the radiation-curable ink jet composition attached on the nozzle surface 37 is cured by the leakage light, and the cleaning properties are further improved. When the content of the polymerization inhibitor in the impregnation liquid is beyond the above range, ink is not easily cured at the time of printing, and the printing tends to be thin.

### Other Components

The impregnation liquid according to the embodiment may contain the organic solvent other than the specific organic solvent. The examples of such an organic solvent will not be described since the organic solvents will be exemplified in the following description of the radiation-curable ink jet composition.

The impregnation liquid according to the embodiment may further contain a material for imparting predetermined performance, such as a pH adjusting agent, a chelating agent, an antiseptic agent, an antifungal agent, and an anti-rust agent.

In a case where the organic solvent containing glycol ethers is used as the impregnation liquid, the impregnation liquid according to the embodiment prevents the radiation-curable ink jet compositions from being aggregated, and prevents the liquid-repellent film of the nozzle surface from being scratched and deteriorated in durability when the aggregates of ink, the ink particularly contains the polymerizable compound having three or more functional groups, and an aggregate derived from an inorganic pigment are scraped at the time of wiping the ink. For this reason, it is possible to realize a method of cleaning an ink jet apparatus having the excellent cleaning properties.

### 1.3. Radiation-Curable Ink Jet Composition

The ink jet apparatus to which the cleaning method according to the embodiment is applied records an image on a recording medium P by using the radiation-curable ink jet composition.

The term “the radiation-curable ink jet composition” in the invention represents an ink composition for ink jet which is used in an ink jet recording method including a curing step of obtaining a cured film by applying active radiation to the radiation-curable ink jet composition attached on the recording medium, and a known material can be used as the radiation-curable ink jet composition.

The radiation-curable ink jet composition used in one embodiment of the invention contains a pigment, a monomer forming an ink film, a polymerization initiator, and an organic solvent. Hereinafter, components contained in the impregnation liquid and components which can be contained in the radiation-curable ink jet composition will be described below.

### Pigment

The ink jet composition can use a pigment as a coloring material, and any of an inorganic pigment and an organic pigment can used as the pigment.

Examples of the inorganic pigment include carbon blacks (C.I. pigment black 7) such as furnace black, lamp black, acetylene black, and channel black; iron oxide; and titanium oxide.

Examples of the organic pigment include azo pigments such as an insoluble azo pigment, a condensed azo pigment, azolake, and a chelate azo pigment, polycyclic pigments such as a phthalocyanine pigment, a perylene and perinone pigment, an anthraquinone pigment, a quinacridone pigment, a dioxane pigment, a thioindigo pigment, an isoindolinone pigment, and quinophthalone pigment, dye chelates (for example, basic dye chelate and acidic dye chelate), dye lakes (for example, basic dye lake and acidic dyelake), a nitro pigment, a nitroso pigment, an aniline black, and a daylight fluorescent pigment.

The carbon black which is used as a black coloring material is not particularly limited; however, examples thereof include No. 2300, No. 900, MCF88, No. 33, No. 40, No. 45, No. 52, MA7, MA8, MA100, and No. 2200B (which are manufactured by Mitsubishi Chemical Corporation); Raven 5750, Raven 5250, Raven 5000, Raven 3500, Raven 1255, and Raven 700 (which are manufactured by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (which are manufactured by CABOT JAPAN K.K.); and Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (which are manufactured by Degussa).

The pigment which is used as a yellow coloring material is not particularly limited; however, examples thereof include C.I. pigments yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

The pigment which is used as a white coloring material is not particularly limited; however, examples thereof include C.I. pigments white 6, 18, and 21, basic lead carbonate, zinc oxide, titanium oxide, and strontium titanate.

The pigment which is used as a magenta coloring material is not particularly limited; however, examples thereof include C.I. pigments red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48 (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, or C.I. pigments violet 19, 23, 32, 33, 36, 38, 43, and 50.

The pigment which is used as a cyan coloring material is not particularly limited; however, examples thereof include C.I. pigments blue 1, 2, 3, 15, 15: 1, 15: 2, 15: 3, 15: 34, 15: 4, 16, 18, 22, 25, 60, 65, and 66, and C.I. pigments bat blue 4 and 60.

In addition, other pigments except for the magenta, cyan, and yellow coloring materials are not particularly limited; however, examples thereof include C.I. pigments green 7 and 10, C.I. pigments brown 3, 5, 25, and 26, and C.I. pigments orange 1, 2, 5, 7, 13, 14, 15, 16, 24, 34, 36, 38, 40, 43, and 63.

The above pigments may be used alone and used in combination with two or more types thereof.

When the above pigments are used, the average particle size of the pigment is preferably in a range of 10 nm to 200 nm, and is more preferably in a range of 50 nm to 150 nm.

An additive amount of the pigment which can be added to the radiation-curable ink jet composition according to the embodiment is preferably in a range of 0.1 mass % to 25 mass %, and is more preferably in a range of 0.5 mass % to 15 mass % with respect to the total mass of the radiation-curable ink jet composition.

Meanwhile, in addition to the pigment, a dye can be used as the coloring material. The dye is not particularly limited; however, examples thereof include an acid dye, a direct dye, a reactive dye, and a basic dye. Polymerizable compound

The radiation-curable ink jet composition may contain a polymerizable compound. The polymerizable compound is polymerized alone or is polymerized by the action of the photopolymerization initiator at the time of light irradiation such that the ink jet composition is cured on the recording medium. The polymerizable compound is not particularly limited; however, specific examples thereof include a monofunctional monomer, a bifunctional monomer, a polyfunctional monomer, and a monofunctional oligomer, a bifunctional oligomer, and a polyfunctional oligomer, which are known in the related art. The polymerizable compound may be used alone or used in combination with two or more types thereof. These polymerizable compounds will be described below.

The monofunctional monomer, the bifunctional monomer, and the monomer having three or more functional groups are not particularly limited; however, examples thereof include an unsaturated carboxylic acid such as a (meth)acrylic acid, an itaconic acid, a crotonic acid, a maleic acid, and an isocrotonic acid; an unsaturated carboxylic acid salt; an unsaturated carboxylic acid ester, urethane, amide, and anhydride; acrylonitrile, styrene, various unsaturated polyesters, unsaturated polyether, unsaturated polyamide, and unsaturated urethane. In addition, the monofunctional oligomer, the bifunctional oligomer, and the oligomer having three or more functional groups are not particularly limited; however, examples thereof include an oligomer formed of the above monomers, such as a straight-chain acrylic oligomer, epoxy(meth)acrylate, oxetane(meth)acrylate, aliphatic urethane(meth)acrylate, aromatic urethane(meth)acrylate, and polyester(meth)acrylate.

In addition, examples of other monofunctional monomers or polyfunctional monomers may include an N-vinyl compound. The N-vinyl compound is not particularly limited; however, examples thereof include N-vinylformamide, N-vinyl carbazole, N-vinyl acetamide, N-vinyl pyrrolidone, N-vinyl caprolactam, and acryloyl morpholine, and derivatives thereof.

The monofunctional (meth)acrylate is not particularly limited; however, examples thereof include isoamyl(meth)acrylate, stearyl (meth)acrylate, lauryl(meth)acrylate, octyl(meth)acrylate, decyl(meth)acrylate, isomyristyl(meth)acrylate, isostearyl(meth)acrylate, 2-ethylhexyl-diglycol(meth)acrylate, 2-hydroxybutyl(meth)acrylate, butoxyethyl(meth)acrylate, ethoxy diethylene glycol(meth)acrylate, methoxy diethylene glycol(meth)acrylate, methoxypolyethylene glycol(meth)acrylate, methoxy propylene glycol(meth)acrylate, phenoxyethyl(meth)acrylate, tetrahydrofurfuryl(meth)acrylate, isobornyl(meth)acrylate, 2-hydroxyethyl(meth)acrylate, 2-hydroxypropyl(meth)acrylate, 2-hydroxy-3-phenoxypropyl(meth)acrylate, lactone-modified flexible (meth)acrylate, t-butyl cyclohexyl(meth)acrylate, dicyclopentanyl(meth)acrylate, and dicyclopentenyl oxyethyl(meth)acrylate. Among them, phenoxyethyl(meth)acrylate is preferably used.

A content of the monofunctional (meth)acrylate is preferably in a range of 30 mass % to 85 mass o, and is more preferably in a range of 40 mass % to 75 mass % with respect to the total mass (100 mass %) of the radiation-curable ink jet composition. When the content of the monofunctional (meth)acrylate is within the above preferable range, there is a tendency that curability, initiator solubility, storage stability, and ejection stability are futher improved.

Examples of the monofunctional (meth)acrylate include a material containing a vinyl ether group. Such a monofunctional (meth)acrylate is not particularly limited; however, examples thereof include (meth)acrylic acid 2-vinyloxyethyl, (meth)acrylic acid 3-vinyloxypropyl, (meth)acrylic acid 1-methyl-2-vinyloxyethyl, (meth)acrylic acid 2-vinyloxypropyl, (meth)acrylic acid 4-vinyloxybutyl, (meth)acrylic acid 1-methyl-3-vinyloxypropyl, (meth)acrylic acid 1-vinyloxymethyl propyl, (meth)acrylic acid 2-methyl-3-vinyloxypropyl, (meth)acrylic acid 1, 1-dimethyl-2-vinyloxyethyl, (meth)acrylic acid 3-vinyloxybutyl, (meth)acrylic acid 1-methyl-2-vinyloxypropyl, (meth)acrylic acid 2-vinyloxybutyl, (meth)acrylic acid 4-vinyloxy cyclohexyl, (meth)acrylic acid 6-vinyloxyhexyl, (meth)acrylic acid 4-vinyloxymethyl cyclohexyl methyl, (meth)acrylic acid 3-vinyloxymethyl cyclohexyl methyl, (meth)acrylic acid 2-vinyloxymethyl cyclohexyl methyl, (meth)acrylic acid p-vinyloxymethyl phenyl methyl, (meth)acrylic acid m-vinyloxymethyl phenyl methyl, (meth)acrylic acid o-vinyloxymethyl phenyl methyl, (meth)acrylic acid 2-(vinyloxy ethoxy)ethyl, (meth)acrylic acid 2-(vinyloxy isopropoxy)ethyl, (meth)acrylic acid 2-(vinyloxy ethoxy)propyl, (meth)acrylic acid 2-(vinyloxy ethoxy)isopropyl, (meth)acrylic acid 2-(vinyloxy isopropoxy)propyl, (meth)acrylic acid 2-(vinyloxy isopropoxy)isopropyl, (meth)acrylic acid 2-(vinyloxy ethoxy ethoxy)ethyl, (meth)acrylic acid 2-(vinyloxy ethoxy isopropoxy)ethyl, (meth)acrylic acid 2-(vinyloxy isopropoxy ethoxy)ethyl, (meth)acrylic acid 2-(vinyloxy isopropoxy isopropoxy)ethyl, (meth)acrylic acid 2-(vinyloxy ethoxy ethoxy)propyl, (meth)acrylic acid 2-(vinyloxy ethoxy isopropoxy)propyl, (meth)acrylic acid 2-(vinyloxy isopropoxy ethoxy)propyl, (meth)acrylic acid 2-(vinyloxy isopropoxy isopropoxy) propyl, (meth)acrylic acid 2-(vinyloxy ethoxy ethoxy)isopropyl, (meth)acrylic acid 2-(vinyloxy ethoxy isopropoxy)isopropyl, (meth)acrylic acid 2-(vinyloxy isopropoxy ethoxy)isopropyl, (meth)acrylic acid 2-(vinyloxy isopropoxy isopropoxy)isopropyl, (meth)acrylic acid 2-(vinyloxy ethoxy ethoxy ethoxy)ethyl, (meth)acrylic acid 2-(vinyloxy ethoxy ethoxy ethoxy ethoxy)ethyl, (meth)acrylic acid 2-(isopropenoxy ethoxy)ethyl, (meth)acrylic acid 2-(isopropenoxy ethoxy ethoxy)ethyl, (meth)acrylic acid 2-(isopropenoxy ethoxy ethoxy ethoxy)ethyl, (meth)acrylic acid 2-(isopropenoxy ethoxy ethoxy ethoxy ethoxy)ethyl, (meth)acrylic acid polyethylene glycol monomethyl ether, and (meth)acrylic acid polypropylene glycol monomethyl ether, phenoxyethyl(meth)acrylate, isobornyl (meth)acrylate, and benzyl(meth)acrylate. Among them, (meth)acrylic acid 2-(vinyloxy ethoxy)ethyl, phenoxyethyl(meth)acrylate, isobornyl(meth)acrylate, and benzyl(meth)acrylate are preferably used.

Among them, in order to realize the radiation-curable ink jet composition which has the low viscosity, a high ignition point, and the excellent curability of the ink jet composition, it is preferable to use any one of (meth)acrylic acid 2-(vinyloxy ethoxy)ethyl, that is, acrylic acid 2-(vinyloxy ethoxy)ethyl and methacrylic acid 2-(vinyloxy ethoxy)ethyl, and it is more preferable to use acrylic acid 2-(vinyloxy ethoxy)ethyl. The aforementioned acrylic acid 2-(vinyloxy ethoxy)ethyl and methacrylic acid 2-(vinyloxy ethoxy)ethyl both have a simple structure and small molecular weight, and thus it is possible to realize the radiation-curable ink jet composition having the remarkably low viscosity. Examples of the (meth)acrylic acid 2-(vinyloxy ethoxy)ethyl include (meth)acrylic acid 2-(2-vinyloxy ethoxy)ethyl and (meth)acrylic acid 2-(1-vinyloxy ethoxy)ethyl, and examples of the acrylic acid 2-(vinyloxy ethoxy)ethyl include acrylic acid 2-(2-vinyloxy ethoxy)ethyl and acrylic acid 2-(1-vinyloxy ethoxy)ethyl. In addition, the acrylic acid 2-(vinyloxy ethoxy)ethyl is more excellent than the (meth)acrylic acid 2-(vinyloxy ethoxy)ethyl in terms of the curability.

The above-described vinyl ether group containing (meth)acrylic acid esters, particularly, a content of the (meth)acrylic acid 2-(vinyloxy ethoxy)ethyl is preferably in a range of 10 mass % to 70 mass %, and is more preferably in a range of 30 mass % to 50 mass %, with respect to the total content (100 mass %) of the radiation-curable ink jet composition. When the content of the (meth)acrylic acid 2-(vinyloxy ethoxy)ethyl is equal to or greater than 10 mass %, there is a tendency that it is possible to realize the radiation-curable ink jet composition having the low viscosity, and the curability of the radiation-curable ink jet composition is further improved. On the other hand, when the content of the (meth)acrylic acid 2-(vinyloxy ethoxy)ethyl is equal to or less than 70 mass %, there is a tendency that the preservability of the ink jet composition becomes excellent and surface gloss of printed matter is further improved.

Among the above-described (meth)acrylates, bifunctional (meth)acrylate is not particularly limited; however, examples thereof include triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane(meth)acrylate, EO of bisphenol A (ethylene oxide) adduct di(meth)acrylate, PO bisphenol A (propylene oxide) adduct di(meth)acrylate, hydroxypivalic acid neopentyl glycol di(meth)acrylate, polytetramethylene glycol di(meth)acrylate, diethylene glycol di(meth)acrylate, triethylene glycol di(meth)acrylate, and a pentaerythritol skeleton, or (meth)acrylate having three or more functional groups and a dipentaerythritol skeleton. Among them, dipropylene glycol di(meth)acrylate is preferably used. In addition, among them, dipropylene glycol di(meth)acrylate, tripropylene glycol di(meth)acrylate, diethylene glycol di(meth)acrylate, triethylene glycol di(meth)acrylate, a pentaerythritol skeleton, or (meth)acrylate having three or more functional groups and a dipentaerythritol skeleton are preferably used. It is more preferable that the radiation-curable ink jet composition contains polyfunctional (meth)acrylate in addition to the monofunctional (meth)acrylate.

A content of polyfunctional (meth)acrylate containing two or more functional group is preferably in a range of 5 mass % to 60 mass %, is more preferably in a range of 15 mass % to 60 mass %, and is still more preferably in a range of 20 mass % to 50 mass %, with respect to the total content (100 mass %) of the radiation-curable ink jet composition. When the content of polyfunctional (meth)acrylate having two or more functional groups is within the above preferable range, there is a tendency that the curability, the storage stability, the ejection stability, and the surface gloss of printed matter are further improved.

Among the aforementioned (meth)acrylates, polyfunctional (meth)acrylate having three or more functional groups is not particularly limited; however, examples thereof include trimethylolpropane tri(meth)acrylate, EO modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerin propoxyphene tri(meth)acrylate, caprolactone modified trimethylolpropane tri(meth)acrylate, pentaerythritol ethoxy tetra(meth)acrylate, and caprolactam modified dipentaerythritol hexa(meth)acrylate.

Among them, the polymerizable compound is preferable to contain the monofunctional (meth)acrylate. In this case, the radiation-curable ink jet composition has the low viscosity, and thus is excellent in dissolving the photopolymerization initiator and other additives, and the ejection stability can be easily obtained at the time of ink jet recoding. Further, since toughness, heat resistance, and chemical resistance of the cured film are enhanced, it is more preferable that the monofunctional (meth)acrylate and bifunctional (meth)acrylate are used in combination with each other. Particularly, it is still more preferable that phenoxyethyl (meth)acrylate and dipropylene glycol di(meth)acrylate used in combination with each other.

The content of polymerizable compound is preferably in a range of 5 mass % to 95 mass %, and is more preferably in a range of 15 mass % to 90 mass % with respect to the total content (100 mass %) of the radiation-curable ink jet composition. When the content of the polymerizable compound is within the above range, it is possible to further reduce the viscosity and odor, and to further improve solubility and reactivity of the photopolymerization initiator, and the surface gloss of printed matter.

### Photopolymerization Initiator

The radiation-curable ink jet composition may contain a photopolymerization initiator. The photopolymerization initiator generates active species such as radical and cation by applying active radiation, and is not particularly limited as long as it causes the polymerization reaction of the monomer to be stated. Examples of the photopolymerization initiator include a photo-radical polymerization initiator and a photocationic polymerization initiator; however, the photo-radical polymerization initiator is preferably used.

In addition, among many types of the radiation, an ultraviolet (UV) ray is excellent in safety and it is possible to reduce the cost of a light source lamp when using the UV ray. Accordingly, the photopolymerization initiator preferably has an absorption peak in the ultraviolet region.

Examples of the photo-radical polymerization initiator include aromatic ketones, an acylphosphine oxide compound, an aromatic onium salt compound, an organic peroxide, a thio compound (a thioxanthone compound, a thiophenyl group-containing compound, and the like), a hexaarylbiimidazole compound, a ketoxime ester compound, a borate compound, an azinium compound, a metallocene compound, an active ester compound, a compound having a carbon-halogen bond, and an alkyl amine compound.

Among them, from the viewpoint that an advantageous effect of excellent solubility and curability with respect to the monomer can be obtained, at least one selected from an acyl phosphine oxide compound and a thioxanthone compound is preferably used, and it is more preferable to use the acyl phosphine oxide compound and the thioxanthone compound in combination with each other.

Specific examples of the photo-radical polymerization initiator include acetophenone, acetophenone benzyl ketal, 1-hydroxycyclohexyl phenyl ketone, 2,2-dimethoxy-2-phenyl acetophenone, xanthone, fluorenone, benzaldehyde, fluorene, anthraquinone, triphenylamine, carbazole, 3-methyl acetophenone, 4-chloro-benzophenone, 4,4′-dimethoxy benzophenone, 4,4′-diamino benzophenone, Michler's ketone, benzoin propyl ether, benzoin ethyl ether, benzyl dimethyl ketal, 1-(4-isopropyl phenyl)-2-hydroxy-2-methyl propan-1-one, 2-hydroxy-2-methyl-1-phenyl-propan-1-one, thioxanthone, diethyl thioxanthone, 2-isopropyl thioxanthone, 2-chloro thioxanthone, 2-methyl-1-[4-(methylthio)phenyl]-2-morpholino-propan-1-one, bis(2,4,6-trimethyl benzoyl)-phenyl phosphine oxide, 2,4,6-trimethyl benzoyl-diphenyl-phosphine oxide, 2,4-diethyl thioxanthone, and bis-(2,6-dimethoxybenzoyl)-2,4,4-trimethylpentyl phosphine oxide.

Examples of commercially available products of the photo-radical polymerization initiator include IRGACURE 651 (2,2-dimethoxy-1,2-diphenyl-ethane-1-one), IRGACURE 184 (1-hydroxy-cyclohexyl-phenyl-ketone), DAROCUR 1173 (2-hydroxy-2-methyl-1-phenyl-propan-1-one), IRGACURE 2959 (1-[4-(2-hydroxyethoxy)-phenyl]-2-hydroxy-2-methyl-1-propan-1-one), IRGACURE 127 (2-hydroxy-1-{4-[4-(2-hydroxy-2-methyl-propionyl)-benzyl]phenyl}-2-methyl-propan-1-one), IRGACURE 907 (2-methyl-1-(4-methyl thiophenyl)-2-morpholino-1-one),

IRGACURE 369 (2-benzyl-2-dimethylamino-1-(4-morpholinophenyl)-butanone-1), IRGACURE 379 (2-(dimethyl amino)-2-[(4-methyl phenyl) methyl]-1-[4-(4-morpholinyl)phenyl]-1-butanone), DAROCUR TPO (2,4,6-trimethyl benzoyl-diphenyl-phosphine oxide), IRGACURE 819 (bis(2,4,6-trimethyl benzoyl)-phenyl phosphine oxide), IRGACURE 784 (bis(115-2,4-cyclopentadien-1-yl)-bis(2,6-difluoro-3-(1H-pyrrol-1-yl)-phenyl)titanium), IRGACURE OXE 01 (1,2-octanedione, 1-[4-(phenylthio)-, 2-(0-benzoyl oxime)]), IRGACURE OXE 02 (ethanone, 1-[9-ethyl-6-(2-methyl benzoyl)-9H-carbazol-3-yl]-, 1-(0-acetyloxime)), IRGACURE 754 (a mixture of an oxy phenylacetic acid and 2-[2-oxo-2-phenyl-acetoxy-ethoxy]ethyl ester, and a mixture of an oxy-phenyl acetic acid and 2-(2-hydroxy ethoxy) ethyl ester), Lucirin TPO, LR8893, and LR8970 (which are manufactured by BASF Japan Ltd.), KAYACURE DETX-S (2,4-diethylthioxanthone) (which are manufactured by Nippon Kayaku Co., Ltd.), Ubecryl P36 (manufactured by UCB Inc.), Speedzcure TPO (diphenyl-2,4,6-trimethyl benzoyl phosphine oxide), and zSpeedcure TPO (diphenyl-(2,4,6-trimethyl benzoyl)phosphine oxide) (which are manufactured by Lambson).

The photopolymerization initiator may be used alone or used in combination with two or more types thereof.

A content of the photopolymerization initiator is preferably in a range of 0.5 mass % to 10 mass % with respect to the total content of the radiation-curable ink jet composition. When the content of the photopolymerization initiator is within the above range, an ultraviolet curing rate is sufficiently large, and dissolution residue of the photopolymerization initiator and the coloring caused by the photopolymerization initiator are less likely to occur. As described above, in a case where the photopolymerization initiator contained in the ink jet composition is a acyl phosphine oxide compound and (or) a thioxanthone compound, a content of the acyl phosphine oxide compound is preferably equal to or greater than 2 mass % with respect to the total content of the radiation-curable ink jet composition. On the other hand, a content of the thioxanthone compound is preferably equal to or greater than 1 mass % with respect to the total content of the radiation-curable ink jet composition.

Note that, as the aforementioned monomer, when a photopolymerizable compound is used, it is possible to omit the addition of a photopolymerization initiator; however, it is preferable to use the photopolymerization initiator such that the start of polymerization can be easily adjusted. Surfactant

The ink jet composition according to the embodiment may further include a surfactant. The surfactant is not particularly limited; however, examples thereof include a silicone-based surfactant (as a commercially available product, for example, BYK UV3500, UV3570 (product name) manufactured by BYK Japan KK)), an acrylic-based surfactant (BYK350 (product name) manufactured by BYK Japan KK)). Among them, in a case of including a silicone-based surfactant, there is a tendency that the surface tension is not deteriorated, wettability with respect to the recording medium is improved, solid filling is further improved, and the surface tension is easily adjusted.

The content of the surfactant is preferably equal to or greater than 0.20 mass %, is more preferably equal to or greater than 0.30 mass %, is still more preferably equal to or greater than 0.40 mass %, and is particularly preferably equal to or greater than 0.50 mass % with respect to the total mass (100 mass %) of the ink jet composition. In addition, the content of the surfactant is preferably equal to or less than 1.0 mass %, is more preferably equal to or less than 0.8 mass %, and is still more preferably equal to or less than 0.7 mass %. When the content of the surfactant is equal to or greater than 0.20 mass o, there is a tendency that the wettability is further improved with respect to the recording medium. In addition, when the content of surfactant is equal to or less than 1.0 mass %, there is a tendency that the liquid repellency of the head nozzle plate is preferably maintained and the ejection stability is further improved.

In addition, the surface tension of the ink jet composition is preferably equal to or less than 23 mN/m and is more preferably equal to or less than 22 mN/m. In addition, the lower limit of the surface tension is not particularly limited, but is preferable as being lowered. When the surface tension is set to be within the above range, there is a tendency that the wettability is further improved with respect to the recording medium. Examples of a method of measuring surface tension include a Wilhelmy method of measuring the surface tension at 25° C. of liquid temperature by using a typically used surface tensiometer (for example, surface tensiometer CBVP-Z (product name) manufactured by Kyowa Interface Science Co., Ltd.).

As the silicone-based surfactant, a polysiloxane compound is preferably used, and examples thereof include polyether-modified organosiloxane. In addition, examples of a commercially available product include BYK-306, BYK-307, BYK-333, BYK-341, BYK-345, BYK-346, and BYK-348 ((product names) which are manufactured by BYK Japan KK), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 ((product names) which are manufactured by Shin-Etsu Chemical Co., Ltd.).

### Dispersant

In a case where the radiation-curable ink jet composition includes a pigment, the pigment dispersibility is further improved, and thus may further include a dispersant. The dispersant is not particularly limited; however, examples thereof include dispersants which are conventionally used to prepare a pigment dispersion liquid such as a polymer dispersant. Specific example thereof include a material having, as a main component, one or more of polyoxyalkylene polyalkylene polyamine, a vinyl-based polymer and a copolymer, an acrylic-based polymer and a copolymer, polyester, polyamide, polyimide, polyurethane, a amino-based polymer, a silicon-containing polymer, a sulfur-containing polymer, a fluorine-containing polymer, and an epoxy resin. Examples of a commercially available product polymer dispersant include Horse Mackerel Spar series manufactured by Ajinomoto Fine-Techno Co., Ltd., Solsperse series (Solsperse 36000) manufactured by Nitto Denko Avecia Inc. and manufactured by Noveon, Inc., DISPERBYK series BYK Chemie, and Disparon series manufactured by Kusumoto Kasei Co., Ltd.

### Other Additives

The radiation-curable ink jet composition may contain other (components) in addition to the above-described additives. Such a component is not particularly limited; however, examples thereof include a slip agent (surfactant), a polymerization accelerator, a penetration enhancer, and a wetting agent (moisturizer), and other additives which are conventionally known. Other additives are not particularly limited; however, examples thereof include an adhesion promoter, fungicide, an antiseptic agent, an antioxidant, an ultraviolet absorber, a chelating agent, a pH adjusting agent, and a thickener which are conventionally known.

### Method of Preparing Radiation-Curable Ink Jet Composition

The radiation-curable ink jet composition according to the embodiment can be obtained by mixing the above-described components in a certain order, and removing impurities through the filtration if necessary. As a method of mixing the respective components, a method of sequentially adding materials to a container, which is provided with a stirring device such as a mechanical stirrer and a magnetic stirrer, and then stirring and mixing the materials is preferably used. As a filtration method, a centrifugal filtration method and a filter filtration method can be performed if necessary.

### Physical Properties of Radiation-Curable Ink Jet Composition

The viscosity of the radiation-curable ink jet composition used in the embodiment is preferably in a range of 5 mPa·s to 50 mPa·s, and is more preferably in a range of mPa·s to 40 mPa·s at 20° C. When the viscosity of the radiation-curable ink jet composition is within the above range at 20° C., an appropriate amount of the radiation-curable ink jet compositions are discharged from the nozzle such that flying curve or scattering of the radiation-curable ink jet composition can be further reduced, and thus it is possible to preferably use the radiation-curable ink jet composition to the ink jet apparatus. Meanwhile, the measurement of the viscosity is performed in such a manner that a shear rate was gradually increased from 10 to 1000 at 20° C., and when the shear rate reaches 200, the viscosity was read by using Modular Compact Rheometer, MCR-300 (manufactured by Anton Paar).

The surface tension of the radiation-curable ink jet composition is preferably in a range of 20 mN/m to 30 mN/m at 20° C. When the surface tension of the radiation-curable ink jet composition is within the above range at 20° C., the radiation-curable ink jet composition is less likely to be wet by nozzles that are subjected to liquid-repellent treatment. With this, an appropriate amount of the radiation-curable ink jet compositions are discharged from the nozzle such that flying curve or scattering of the radiation-curable ink jet composition can be further reduced, and thus it is possible to preferably use the radiation-curable ink jet composition to the ink jet apparatus. In addition, the measurement of the surface tension is performed by confirming the surface tension when the platinum plate is wet by the ink at 20° C., with an automatic surface tension meter CBVP-Z (manufactured by Kyowa Interface Science Co., Ltd). 1.4. Wiping step

As described above, in the wiping step according to embodiment, the nozzle surface 37 of the ink jet head 22 is wiped by the wiping section 30 including the absorber which is impregnated with the organic solvent containing glycol ethers.

More specifically, in the wiping step according to embodiment, as described above, the wiping of the nozzle surface 37 is performed in such a manner that the press member 87 adds the pressing load on the long-shaped wiping member 30 by pressing the long-shaped wiping member 30 with respect to the nozzle surface 37 of the ink jet head 22. Note that, the absorber is impregnated with the impregnation liquid containing the organic solvent is on standby during the recording step of discharging the radiation-curable ink jet composition on the recording medium P, the wiping step is performed after the recording step.

In the ink jet apparatus which records an image by applying the light to the radiation-curable ink jet composition, the nozzle clogging is likely to occur due to reflection light or leakage light at the time of light irradiation; however, in the cleaning method according to the embodiment, since the wiping step is performed by using the above-described impregnation liquid, the radiation-curable ink jet compositions is prevented from being aggregated and thus the cleaning properties of the nozzle surface 37 is further improved. As a result, it is possible to efficiently prevent the occurrence of problems such as the nozzle clogging and the like.

### 1.5. Preliminary Discharging Step

In the method of cleaning an ink jet apparatus according to embodiment, in a case where the impregnation liquid contains the polymerization inhibitor, a preliminary discharge step of preliminary discharging the radiation-curable ink jet composition from the nozzle is performed after the wiping step, and in the preliminary discharging step, it is preferable to provide a nozzle which performs the preliminary discharging, and a nozzle which does not perform the preliminary discharging. When a large amount of the polymerization inhibitors are dispersed in the nozzle 38 immediately after cleaning the nozzle surface 37, the radiation-curable ink jet composition is less likely to be photocured, and if the printing is performed by discharging the ink in this state, image quality is deteriorated. In this regard, in the nozzle row and the nozzle which are used to print an image, the ink in the nozzle is pushed so as to be ejected away after the cleaning. On the other hand, in the nozzle row and the nozzle which are not used to print an image, it is possible to prevent the ink in the vicinity of the nozzle from being cured due to the leakage light at the time of the next printing by maintaining a state where the radiation-curable ink jet composition is not photocured, and thereby alignment deterioration, that is, deterioration of the discharging reliability can be suppressed.

In addition, the nozzle which does not perform the preliminary discharging is a nozzle which is not used at least at the first scanning operation in which the radiation-curable ink jet composition is discharged while relatively changing the positions of the recording medium P and the ink jet head 22, in the first recording operation performed after the preliminary discharging step. The scanning operation is performed by moving the carriage 20 once with respect to the recording medium P illustrated in FIG. 1. In a case of a carriage type printer, if a flushing box is provided on both sides of the printer, the ink can be ejected away by one scanning operation, and thus the nozzle which is not used at least at the first scanning operation is not necessary to perform the preliminary discharging before the first scanning operation. In a case of a line type printer, all printing operations are finished by one scanning operation, and thus the nozzle which does not perform the preliminary discharging is selected depending on whether or not the nozzle is used in the printing.

Whether the preliminary discharging is performed or not may be determined by a nozzle row unit or a nozzle unit. For example, if the use is determined by an ink unit as a case of white ink and color ink, the nozzle row unit is preferably used; however, the nozzle unit can be also used.

### 2. EXAMPLES

Hereinafter, the invention will be further specifically described with reference to Examples and Comparative Examples. However, note that the invention is not limited to Examples.

### 2.1. Preparation of Radiation-Curable Ink Jet Composition

The pigment dispersant was prepared before performing the evaluation regarding the wiping operation. 2 parts by mass of carbon black as a pigment and 1 part by mass of solspers 36000 (manufactured by THE LUBRIZOL CORP) as a dispersant which are used in Composition 1 were added with respect to 100 parts by mass in total, and then were mixed and stirred so as to obtain a mixture. The obtained mixture was subjected to dispersing treatment for 6 hours together with a zirconia bead (having 1.5 mm of diameter) by using a sandmill (manufactured by Yasukawa Seisakusho Co., Ltd). Thereafter, the zirconia bead was separated by using a separator so as to obtain a black pigment dispersion liquid. In addition, in the same way as in the above description, a cyan pigment dispersion liquid, a magenta pigment dispersion liquid, a yellow pigment dispersion liquid, and a white pigment dispersion liquid were obtained.

TABLE 1

| | | Composition 1 | Composition 2 | Composition 3 | Composition 4 | Composition 5 |
|---|---|---|---|---|---|---|
| Polymerizable | PEA | 25 | 25 | 25 | 25 | 25 |
| compound | VEEA | 43.2 | 48.7 | 43.2 | 48.7 | 33.7 |
| | SR508 | 15 | 12 | 15 | 12 | 12 |
| | DPHA | 5 | | 5 | | |
| Surfactant | BYK3500 | 0.2 | 0.2 | 0.2 | 0.2 | 0.2 |
| Polymerization | MEHQ | 0.1 | 0.1 | 0.1 | 0.1 | 0.1 |
| inhibitor | | | | | | |
| Polymerization | Irgacure819 | 5 | 5 | 5 | 5 | 5 |
| initiator | SpeedcureTPO | 4 | 4 | 4 | 4 | 4 |
| Dispersant | Dispersant | 0.5 | 1 | 0.5 | 1 | 5 |
| Pigment | Carbon black | 2 | | | | |
| | PR122 | | 4 | | | |
| | PB15:3 | | | 2 | | |
| | PY155 | | | | 4 | |
| | Titanium oxide | | | | | 15 |

| | | | | | |
|---|---|---|---|---|---|
| Total | 100 | 100 | 100 | 100 | 100 |

Subsequently, the polymerizable compound, the surfactant, the polymerization inhibitor, the polymerization initiator, and the dispersant were mixed so as to be the composition (mass %) indicated in Table 1, completely dissolved, and mixed and stirred at a normal temperature for 1 hour. Each of the pigment dispersion liquids was added dropwise into the obtained mixture while being stirred such that the density of the black pigment becomes the density indicated in Table 1. After adding dropwise the pigment dispersion liquid, mixing and stirring is performed at a normal temperature for 1 hour, and filtering is performed by using a 5 μm of membrane filter so as to obtain a black radiation-curable ink jet composition of Composition 1. In the same way, Composition 2 (a magenta radiation-curable ink jet composition), Composition 3 (a cyan radiation-curable ink jet composition), Composition 4 (a yellow radiation-curable ink jet composition), and Composition 5 (a white radiation-curable ink jet composition) were obtained.

In addition, the components used in Table 1 are as follows.

### (1) Polymerizable Compound

PEA (Phenoxy acrylate, manufactured by Osaka Organic Chemical Industry Ltd., product name: “VISCOAT #192”)

VEEA (acrylic acid 2-(2-hydroxyethoxy)ethly, Nippon Shokubai Co., Ltd.)

SR508 (dipropylene glycol diacrylate, manufactured by Sartomer Co., Inc.)

DPHA (dipentaerythritol hexaacrylate, manufactured by Shin Nakamura Chemical Industry Co., Ltd.)

### (2) Surfactant

BYK-UV3500 (manufactured by BYK Japan KK, polydimethylsiloxane having a polyether-modified acrylic group)

### (3) Polymerization Inhibitor

MEHQ (p-methoxyphenol, manufactured by East Chemical Co., Ltd.)

### (4) Polymerization Initiator

IRGACURE 819 (manufactured by Ciba Japan Co., Ltd., bis(2,4,6-trimethyl benzoyl)-phenyl phosphine oxide)

Speedcure TPO (diphenyl-(2,4,6-trimethyl benzoyl)phosphine oxide manufactured by Lambson)

### (5) Dispersant

color: solspers 36000 (manufactured by THE LUBRIZOL CORP)

Titanium oxide: BYK180 (manufactured by BYK Japan KK)

### (6) Pigment

carbon black—PB15: 3 (C.I. pigment blue 15: 3)

PR122 (C.I. pigment red 122)

PY155 (C.I. pigment yellow 155)

Titanium oxide

### 2.2. Evaluation Regarding Wiping Operation

The evaluation regarding wiping operation is performed by using the composition of the impregnation liquid which is indicated in Table 2.

TABLE 2

| | | Number | | | | | | | | Compar- | | Compar- |
|---|---|---|---|---|---|---|---|---|---|---|---|---|
| | Composition of | of | Exam- | Exam- | Exam- | Exam- | Exam- | Exam- | Exam- | ative | Comparative | ative |
| | Impregnation Liquid | carbons | ple 1 | ple 2 | ple 3 | ple 4 | ple 5 | ple 6 | ple 7 | Example 1 | Example 2 | Example 3 |
| Organic | diethylene glycol mono | 7 | 99.7 | | | | | | | | | |
| solvent | methyl ether acetate | | | | | | | | | | | |
| | diethylene glycol mono | 8 | | 99.7 | | | | | | | | |
| | ethyl ether acetate | | | | | | | | | | | |
| | diethylene glycol mono | 10 | | | 99.7 | | | | | | | |
| | butyl ether acetate | | | | | | | | | | | |
| | ethylene glycol mono | 5 | | | | 99.7 | | 99.7 | 99.7 | | | |
| | methyl ether acetate | | | | | | | | | | | |
| | propylene glycol mono | 6 | | | | | 99.7 | | | | | |
| | methyl ether acetate | | | | | | | | | | | |
| | Diethylene glycol mono | 6 | | | | | | | | 99.7 | | |
| | ethyl ether | | | | | | | | | | | |
| | Polyethylene glycol | | | | | | | | | | 99.7 | |
| | Triethylene glycol | 10 | | | | | | | | | | 99.7 |
| | diethyl ether | | | | | | | | | | | |
| Surfac- | BYK-UV3500 | | 0.3 | 0.3 | 0.3 | 0.3 | 0.3 | | | 0.3 | 0.3 | 0.3 |
| tant | Surfynol E1010 | | | | | | | 0.3 | 0.3 | | | |

| | | | | | | | | | | |
|---|---|---|---|---|---|---|---|---|---|---|
| Total | 100 | 100 | 100 | 100 | 100 | 100 | 100 | 100 | 100 | 100 |

| | | | | | | | | | | | |
|---|---|---|---|---|---|---|---|---|---|---|---|
| Test | Wiping properties for ink | A | A | A | A | A | A | A | B | C | B |
| result | before performing light | | | | | | | | | | |
| | exposure on nozzle | | | | | | | | | | |
| | surface | | | | | | | | | | |
| | Wiping properties for ink | A | A | A | A | A | B | A | C | C | C |
| | after performing light | | | | | | | | | | |
| | exposure on nozzle | | | | | | | | | | |
| | surface | | | | | | | | | | |
| | Discharging reliability | B | A | A | B | B | B | A | C | C | C |
| | Evaluation of volatility * | 0.38% | 0.23% | 0.08% | 0.50% | 0.50% | 0.50% | 0.50% | 0.56% | 1.08% | 0.47% |
| | Volatility rate [%] | | | | | | | | | | |
| | Wiping properties for ink | A | A | A | B | B | B | B | C | C | C |
| | for long period of time | | | | | | | | | | |

2.2.1. Evaluation of Wiping Properties for Ink before Performing Light Exposure on Nozzle Surface

SC-S50650 manufactured by EPSON was reformed so as to be used as a printer, and an irradiation light source LED having 395 nm of peak wavelength was installed as a light source on the left and right of the head of the carriage. Each of five nozzles rows of the head was filled with different color ink (five colors of ink in total which are prepared in 2.1.). Here, one nozzle row has 360 nozzles. As first, the printing operation of discharging the ink to the recording medium was performed for 5 minutes by using the entire nozzles. In Examples, the light source was turned off for the experiment. Subsequently, the entire nozzles were capped and suction cleaning was performed, then wiping was performed, and then the wiping properties of the ink with respect to the nozzle surface were evaluated. In addition, Example 7 is performed in the same manner as Example 6 except that two rows of Composition 2, two rows of Composition 4, and one row of Composition 5 were set as the ink. In other words, Example 7 is an example of using the ink which does not contain a monomer having three or more functional groups.

As the absorber (a fabric wiper), cellulose filament nonwoven fabrics (product name: Bemliese) was used and impregnated with 80 mass % of impregnation liquid with respect to 100 mass % of absorber. The wiping operation is performed in such a manner that a top surface was moved from one end to the other end by 20 cm in the direction orthogonal with respect to the nozzle row in a state where the wiping section (the absorber) came in contact with the nozzle plate, and a pressing force having 100 kf of load was applied to the range from the rear side of the wiping section to the nozzle plate by using the press member. As illustrated in FIG. 3, the wiping section was formed into a roll shape, and pulled out a new portion so as to use for the next wiping.

Evaluation criteria of the wiping properties for ink evaluation are as follows.

A: ink is clearly wiped on nozzle plate, and step portion between nozzle plate and head cover.

B: ink slightly remains on step portion.

C: a large amount of unwiped ink remains on nozzle plate.

2.2.2. Evaluation of Wiping Properties for Ink after Performing Light Exposure on Nozzle Surface

After performing the operation of wiping described in 2.2.1, an irradiation light source of the printer was turned on, the printing was performed while performing the light exposure on the nozzle surface under the light irradiation conditions such that illuminance and light intensity are respectively set to 25 μW/cm² and 4800 mJ/cm², and then the evaluation after performing the suction cleaning described in 2.2.1 was performed. In other words, the wiping described in 2.2.1 was performed after the light exposure was performed in a state where the impregnation liquid is attached on the nozzle surface, and then the wiping properties for ink with respect to nozzle surface is evaluated in the same manner as 2.2.1.

2.2.3. Evaluation of Discharging Reliability after Performing Light Exposure on Nozzle Surface

Subsequent to the wiping described in 2.2.2, a discharging test of the nozzle was performed. The illuminance of the nozzle surface is affected by the reflection light or the leakage light of the irradiation light source, and thus the printing was performed with the above-described illuminance while the irradiation light source becomes the above-described light intensity. Here, an equation expressed by illuminance X irradiation time =light intensity (irradiation energy) is established. The cleaning (suction and wiping) and the discharging test was assumed to be one set, and then cleaning inducibility (discharging reliability) was evaluated by repeatedly performing the above set operation. The evaluation criteria are as follows.

A: it becomes normal discharge in 2 sets or less

B: it becomes normal discharge in 3 sets

C: it may not recover even in 3 sets or more

### 2.2.4. Evaluation of Volatility

Each of the impregnation liquids was put into a glass bottle and then was left to stand for 3 days at 20° C. so as to check the change in weight, at this time a mouth of the glass bottle was opened. The numerical value represents volatilization rate (%).

### 2.2.5. Evaluation of Wiping Properties for Ink for Ink for Long Period of Time

The evaluation was performed in the same manner as 2.2.1 except that fabric wiper was impregnated with the impregnation liquid, and then released and left to stand for 1 month at a temperature and humidity.

### 2.2.6. Evaluation Regarding Wiping Operation

Evaluation regarding the wiping operation is indicated in Table 2. In Examples in which glycol ethers are used as the impregnation liquid, particularly after performing the light exposure, the wiping properties for ink were greatly different from those in Comparative Examples in which glycols and glycol ethers are used as the organic solvent, and the wiping properties were great for foreign matters generated from the ink which is partially cured due to the light exposure. In other words, it was found that the impregnation liquids in Examples not only serves as a cleaning liquid for wiping the ink attached on the nozzle surface, but also has a function of softening the cured foreign matters generated from the ink which is partially cured, and thus is useful to wipe the nozzle surface on which the ink including the cured foreign matters is attached. Particularly, in Examples 2 and 3 in which glycol ethers have a large number of the carbons, it was possible to clearly wipe the ink attached on the nozzle surface without generating the aggregates after the wiping. In Examples 1, 4 to 6 in which glycol ethers have a less number of carbons, the number of carbons in glycol ethers which were used as the organic solvent was small, and thus the solvent had hygroscopicity, thereby generating the aggregates after the wiping. Since Example 7 is an example of using the ink which does not include the monomer having three or more functional groups, the aggregates were not generated as in Example 6. Meanwhile, in Comparative Examples, it is considered that glycols and glycol ethers which are used as the organic solvent do not have compatibility with the ink, and thus the wiping properties for ink is deteriorated.

In addition, regarding the discharging reliability after performing the light exposure on the nozzle surface, in a case of using the impregnation liquid having excellent wiping properties for ink in Examples, the ink which is solidified (partially cured) due to the light exposure is prevented from being scraped on nozzle surface at the time of wiping with the fabric wiper, and thus the cleaning inducibility is improved. As a result, the nozzles of Examples were normally discharge ink within 3 sets. Among them, the nozzles of Examples 2, 3, and 7 n which the aggregates were not generated had high discharging reliability. In contrast, it was found that in Comparative Examples in which the wiping properties for ink were deteriorated, the discharging reliability even after performing the light exposure on the nozzle surface was also deteriorated.

Further, regarding the evaluation of the wiping properties for ink for ink for a long period of time, even in Examples, as the number of carbons in glycol ethers is large, the solvent has the low volatility, and thus it was found that in Examples 1 to 3, even in a case where the fabric wiper which is impregnated with the solvent is on standby, it is possible to wipe the ink for a long period of time without deteriorating the cleaning properties since the organic solvent is volatilized while being on standby, as compared with other Examples.

The present invention is not limited to the above embodiments, and various modifications are possible. For example, the invention includes configurations substantially the same as the configurations described in the embodiments (for example, a configuration having the same function, method, and result, or a configuration having the same purpose and effect). The invention also includes a configuration that replaces non-essential parts of the configuration described in the embodiments. The invention also includes a configuration that can exhibit the same action and effect or a configuration that can achieve the same purpose as those of the configuration described in the embodiment. The invention also includes a configuration obtained by adding a known technique to the configuration described in the embodiment.

The entire disclosure of Japanese Patent Application No. 2015-036437, filed Feb. 26, 2015 is expressly incorporated by reference herein.

What is claimed is:

1. A method of cleaning an ink jet apparatus which discharges a radiation-curable ink jet composition, the method comprising:
wiping a nozzle surface of an ink jet head by using a wiping section that is provided with an absorber which is impregnated with an organic solvent containing glycol ethers.

2. The method of cleaning an ink jet apparatus according to claim 1,
wherein the number of carbons of the glycol ethers is equal to or greater than 8.

3. The method of cleaning an ink jet apparatus according to claim 1,
wherein the glycol ethers are glycol ether ester.

4. The method of cleaning an ink jet apparatus according to claim 1,
wherein the absorber which is impregnated with the organic solvent is on standby while discharging the radiation-curable ink jet composition to a recording medium, and then the wiping is performed after the discharging of the radiation-curable ink jet composition.

5. The method of cleaning an ink jet apparatus according to claim 1,
wherein the radiation-curable ink jet composition is a radiation-curable composition containing a polymerizable compound having three or more functional groups.

6. The method of cleaning an ink jet apparatus according to claim 1,
wherein the absorber is further impregnated with a surfactant.

7. The method of cleaning an ink jet apparatus according to claim 6,
wherein the surfactant is at least one selected from the group consisting of polyether-modified silicone, polyester-modified silicone, and acetylene diol.

8. An ink jet apparatus that performs cleaning through the cleaning method according to claim 1.

9. An ink jet apparatus that performs cleaning through the cleanin method according to claim 2.

10. An ink jet apparatus that performs cleaning through the cleaning method according to claim 3.

11. An ink jet apparatus that performs cleaning through the cleaning method according to claim 4.

12. An ink jet apparatus that performs cleaning through the cleaning method according to claim 5.

13. An ink jet apparatus that performs cleaning through the cleaning method according to claim 6.

14. An ink jet apparatus that performs cleaning through the cleaning method according to claim 7.
